(19) United States
(12) Patent Application Publication
(10) Pub. No.: US 2023/0413352 A1
(43) Pub. Date: Dec. 21, 2023

(54) NON-TRANSITORY COMPUTER-READABLE STORAGE MEDIUM, CONTROL METHOD, COMMUNICATION APPARATUS, AND COMMUNICATION SYSTEM

(71) Applicant: Canon Kabushiki Kaisha, Tokyo (JP)

(72) Inventor: MASAKI OTSUKA, Kanagawa (JP)

(21) Appl. No.: 18/326,112

(22) Filed: May 31, 2023

(30) Foreign Application Priority Data
Jun. 15, 2022 (JP) 2022-096758

(51) Int. Cl. H04W 76/10; H04W 48/20; H04W 12/06

(52) U.S. Cl. CPC H04W 76/10; H04W 48/20; H04W 12/06

(57) ABSTRACT

A non-transitory computer-readable storage medium storing a program for causing a computer of an information processing apparatus that can wirelessly communicate with a communication apparatus to function as: a first obtaining unit configured to obtain supported scheme information relating to a setup scheme supported by the communication apparatus; and a transmission control unit configured to control the information processing apparatus to transmit to the communication apparatus a specific signal for enabling network setup using a first scheme for connecting the communication apparatus to an access point other than the communication apparatus, wherein the specific signal is transmitted to the communication apparatus when the supported scheme information indicates that the communication apparatus supports network setup using the first scheme and the specific signal is not transmitted when the supported scheme information indicates that the communication apparatus does not support network setup using the first scheme.

### BACKGROUND OF THE INVENTION

### Field of the Invention

The present invention relates to a non-transitory computer-readable storage medium, a control method, a communication apparatus, and a communication system relating to the network setup of a communication apparatus.

### Description of the Related Art

There has been an increase in cases of an electronic device, such as a digital camera, printer, mobile phone, smartphone, and the like, being installed with a wireless communication function and these devices being connected to a wireless network and used as a communication apparatus. To connect an electronic device to a wireless network, various communication parameters, such as an encryption method, encryption key, authentication method, authentication key, and the like, must be set. This makes setting the communication parameters complicated, which can be an obstacle for users of digital cameras and printers. Thus, systems are used to simplify the setup of communication parameters. Also, to prevent information leakage of the communication parameters and the like, a system is used in which the communication parameters are made confidential via a public key encryption method and sent to a user terminal.

One such example is Wi-Fi Easy Connect (WEC) using Device Provisioning Protocol (DPP) which is a system for exchanging network information between devices standardized by the Wi-Fi Alliance. With WEC, communication is started by providing a public key to a device corresponding to a communication partner, with examples of the method of bootstrapping corresponding to the trigger for the exchange of network information including QR code (registered trademark), BLE, NFC, and the like.

The technique described in Japanese Patent Laid-Open No. 2006-261938 makes setting the communication parameters on a communication terminal easy by using a QR code (registered trademark) image including communication parameter information as a medium. Also, the technique described in Japanese Patent Laid-Open No. 2019-180036 includes outputting a QR code (registered trademark) to an output unit after a printer receives a specific signal from a terminal.

### SUMMARY OF THE INVENTION

In Japanese Patent Laid-Open No. 2019-180036, even when the printer does not support WEC, the terminal transmits the specific signal to the printer. As a result, the printer does not react to the specific signal and network setup of the printer fails, thus problematically reducing the user-friendliness for the user when performing network setup for a communication apparatus.

Regarding this, the present invention is directed at providing techniques for improving user-friendliness when performing network setup for a communication apparatus.

According to the present disclosure, there is provided a non-transitory computer-readable storage medium storing a program for causing a computer of an information processing apparatus that can wirelessly communicate with a communication apparatus to function as: a first obtaining unit configured to obtain supported scheme information relating to a setup scheme supported by the communication apparatus; and a transmission control unit configured to control the information processing apparatus to transmit to the communication apparatus a specific signal for enabling network setup using a first scheme for connecting the communication apparatus to an access point other than the communication apparatus, wherein the transmission control unit controls the information processing apparatus to: transmit the specific signal to the communication apparatus when the supported scheme information indicates that the communication apparatus supports network setup using the first scheme; and not transmit the specific signal when the supported scheme information indicates that the communication apparatus does not support network setup using the first scheme.

According to the present invention, techniques can be provided for improving user-friendliness when performing network setup for a communication apparatus.

Further features of the present invention will become apparent from the following description of exemplary embodiments (with reference to the attached drawings).

### BRIEF DESCRIPTION OF THE DRAWINGS

FIG. 1 is a diagram illustrating the configuration of a communication system including an information processing apparatus and a communication apparatus.

FIG. 2 is a sequence diagram illustrating the processing executed by the information processing apparatus and the communication apparatus.

FIG. 3 is a diagram illustrating an example of a WEC start screen displayed by the information processing apparatus via a WEC application.

FIGS. 4A and 4B are a flowchart illustrating an example of network setup processing for the communication apparatus executed by the information processing apparatus when unconnected to an access point.

FIG. 5A is a diagram illustrating an example of a UI screen of the information processing apparatus.

FIG. 5B is a diagram illustrating an example of a UI screen of the information processing apparatus.

FIG. 5C is a diagram illustrating an example of a UI screen of the information processing apparatus.

FIG. 5D is a diagram illustrating an example of a UI screen of the information processing apparatus.

FIG. 6 is a flowchart illustrating an example of network setup processing for the communication apparatus executed by the information processing apparatus when connected to an access point.

FIG. 7 is a flowchart illustrating an example of processing executed by the communication apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

An information processing apparatus 101 and a communication apparatus 151 included in a communication system according to the present embodiment will now be described. In the present embodiment, a smartphone is used as an example of the information processing apparatus 101, but no such limitation is intended. Various devices can be used for the information processing apparatus 101 including a portable terminal, a PC, a tablet terminal, a personal digital assistant (PDA), a digital camera, and the like. Also, in the present embodiment, a printer is used as an example of the communication apparatus 151, but no such limitation is intended. Various devices can be used as long as the apparatus can wirelessly communicate with the information processing apparatus 101. For example, in the case of a printer, an inkjet printer, a full color laser beam printer, a monochrome printer, or the like may be used. Also, the communication apparatus can be not only a printer but may be a copy machine or a facsimile machine, a portable terminal, a smartphone, a notebook PC, a tablet terminal, a PDA, a digital camera, a music playback device, a television, a smart speaker, or the like. A multi-function peripheral provided with a plurality of functions, such as a copying function, a FAX function, a printing function, and the like, may also be used.

Also, in the present embodiment, in a case in which the information processing apparatus 101 supports the function known as Wi-Fi Easy Connect (hereinafter, referred to as WEC), the information processing apparatus 101 can execute this function. WEC refers to a function for executing network setup of another apparatus using the Device Provisioning Protocol (hereinafter, referred to as DPP) established by the Wi-Fi Alliance. Note that the network setup of another apparatus means processing to connect this other apparatus to an access point forming the network.

With WEC, communication is performed between an apparatus (hereinafter, referred to as a configurator apparatus) that operates with the role of a configurator and an apparatus (hereinafter, referred to as an enrollee apparatus) that operates with the role of an enrollee. The configurator apparatus obtains bootstrapping information from the enrollee apparatus. The bootstrapping information includes, for example, identification information (MAC address and the like) of the enrollee apparatus, public key information used for securely communicating with the enrollee apparatus, and the like. In the present embodiment, the bootstrapping information is described as WEC related information. Note that other information may also be used as WEC related information. Also, the configurator apparatus uses the obtained bootstrapping information to perform wireless communication with the enrollee apparatus. Specifically, for example, the configurator apparatus encrypts a protocol key using the public key included in the bootstrapping information and transmits the encrypted protocol key to the enrollee apparatus. Also, the configurator apparatus encrypts a common key on the basis of the encrypted protocol key and transmits information encrypted using the common key to the enrollee apparatus. Note that herein, the information transmitted is specifically connection information for connecting to an access point, for example. Then, the enrollee apparatus establishes a wireless connection with the access point using the connection information received from the configurator apparatus. Note that in the network setup processing via WEC according to the present embodiment described herein, the information processing apparatus 101 that supports WEC operates as the configurator apparatus. Also herein, the communication apparatus 151 that supports WEC operates as the enrollee apparatus.

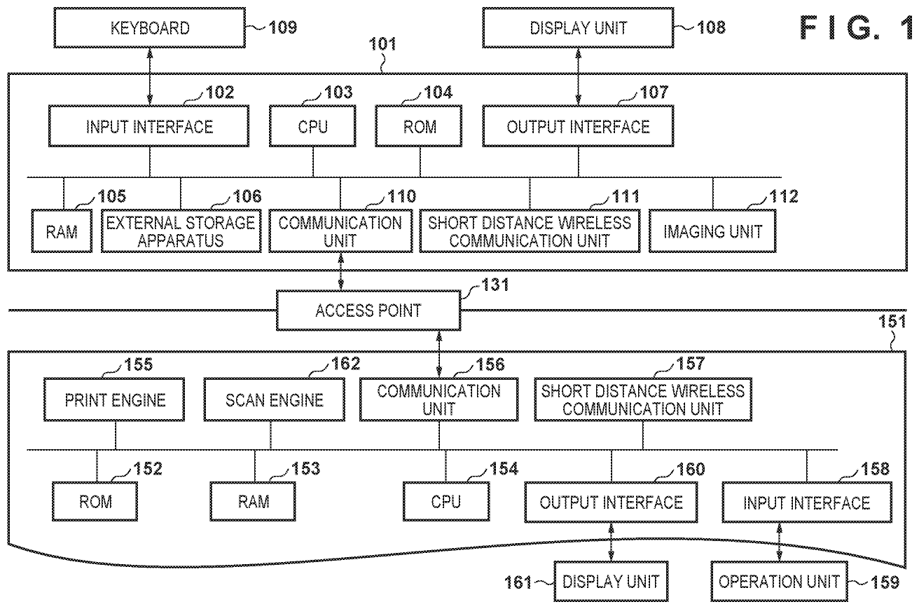

First, the configuration of the information processing apparatus 101 according to the present embodiment and the configuration of the communication apparatus 151 that can communicate with the information processing apparatus 101 according to the present embodiment will be described with reference to the block diagram of FIG. 1. Also, the present embodiment is described below using the following configuration as an example, but the configuration is not limited to the illustrated functions. A configuration supporting functions that can be implemented by devices that can be used as apparatuses that can communicate with one another may be provided as appropriate.

The information processing apparatus 101 includes an input interface 102, a CPU 103, a ROM 104, a RAM 105, an external storage apparatus 106, an output interface 107, a display unit 108, a communication unit 110, a short distance wireless communication unit 111, and an imaging unit 112. The computer of the information processing apparatus 101 that executes a program is formed by the CPU 103, the ROM 104, the RAM 105, and the like.

The input interface 102 is an interface for accepting data input and operation instruction from the user via the operation of an operation unit such as a keyboard 109 or the like. Note that the operation unit may be a physical keyboard, a physical button, or the like or may be a software keyboard, software button, or the like displayed on the display unit 108. In other words, the input interface 102 may accept input from the user via the display unit 108.

The CPU 103 is a system control unit that controls the entire information processing apparatus 101. The ROM 104 stores fixed data, such as a control program executed by the CPU 103, data tables, a built-in operating system (hereinafter referred to as OS) program, and the like. In the present embodiment, the respective control programs stored in the ROM 104 control the execution of software, such as scheduling, task switching, and interrupt processing, under the management of the built-in OS stored in the ROM 104.

The RAM 105 is constituted by a static random-access memory (SRAM) and the like that requires a backup power supply. Note that because the RAM 105 stores the data via a non-illustrated primary cell for data backup, the data required for program control variables and the like can be stored without volatilization. Also, the RAM 105 is also provided with a memory area for storing setting information of the information processing apparatus 101, management data of the information processing apparatus 101, and the like. The RAM 105 is also used as the main memory and the working memory of the CPU 103.

The external storage apparatus 106 stores an application program (hereinafter, referred to as a setting application) for executing the network setup of the communication apparatus 151, a printing information creation program for creating printing information that can be interpreted by the communication apparatus 151, and the like. The setting application is an application program for setting the settings of the connection destination access point of the communication apparatus 151 using WEC or the like. Note that the setting application may be provided with another function other than the network setup function. For example, the setting application may be provided with a function for causing the communication apparatus 151 to execute printing, a function for causing a document set on a platen of the communication apparatus 151 to be scanned, a function for confirming the state of the communication apparatus 151, and the like. The setting application, for example, is stored in the external storage apparatus 106 by being installed from an external server using internet communication via the communication unit 110. Also, the external storage apparatus 106 stores the various types of programs, such as an information transceiving control program for transceiving with the communication apparatus 151 connected via the communication unit 110, and various types of information used by the programs.

The output interface 107 is an interface for performing control for the display unit 108 to display data and communicate the state of the information processing apparatus 101. The display unit 108 is constituted by a light-emitting diode (LED), a liquid crystal display (LCD), or the like and displays data and communicates the state of the information processing apparatus 101.

The communication unit 110 is configured to connect to an apparatus, such as the communication apparatus 151 or an access point 131, and perform data communication. For example, the communication unit 110 can connect to an access point (not illustrated) inside the communication apparatus 151. By connecting the communication unit 110 and an access point inside the communication apparatus 151, the information processing apparatus 101 and the communication apparatus 151 can communicate with one another. Note that the communication unit 110 may communicate directly with the communication apparatus 151 via wireless communication or may communicate via an external apparatus located outside of the information processing apparatus 101 and the communication apparatus 151. Note that the external apparatus includes an external access point (the access point 131 or the like) or an apparatus that can rely communications other than an access point located outside of the information processing apparatus 101 and outside of the communication apparatus 151. In the present embodiment, the wireless communication scheme used by the communication unit 110 is Wi-Fi (registered trademark) which is a communication standard compliant with the IEEE 802.11 series. Also, the WEC described above is performed by communication via the communication unit 110. Examples of the access point 131 include, for example, a wireless LAN router, and other similar devices. Note that in the present embodiment, the scheme of connecting the information processing apparatus 101 and the communication apparatus 151 directly without using an external access point is referred to as a direct connection scheme. Also, the scheme of connecting the information processing apparatus 101 and the communication apparatus 151 via an external access point is referred to as an infrastructure connection scheme.

The short distance wireless communication unit 111 is configured to wirelessly connect at short distances to an apparatus such as the communication apparatus 151 and perform data communication and perform communication using a communication scheme other than via the communication unit 110. The short distance wireless communication unit 111 can connect to a short distance wireless communication unit 157 inside the communication apparatus 151, for example. Examples of the communication scheme include, for example, NFC, Bluetooth (registered trademark) Classic, Bluetooth Low Energy (BLE), Wi-Fi Aware, and the like.

The imaging unit 112 is a camera that captures images of the outside, for example. In the present embodiment, the information processing apparatus 101 further includes a not-illustrated barcode reading control unit. The barcode reading control unit parses an image captured by the imaging unit 112, which is a camera for example, and obtains encoded code information. The barcode reading control unit executes parsing processing of code information, such as a barcode, a two-dimensional code, a QR code (registered trademark), or the like.

In the present embodiment, the information processing apparatus 101 executes WEC using the OS of the information processing apparatus 101 on the basis of an instruction to execute network setup processing by the setting application.

The communication apparatus 151 is a communication apparatus according to the present embodiment. The communication apparatus 151 includes a ROM 152, a RAM 153, a CPU 154, a print engine 155, a communication unit 156, and the short distance wireless communication unit 157. The computer of the communication apparatus 151 that executes a program is formed by the ROM 152, the RAM 153, the CPU 154, and the like.

The communication unit 156 includes, as an access point inside the communication apparatus 151, an access point for connecting to an external apparatus such as the information processing apparatus 101. Note that this access point can connect to the communication unit 110 of the information processing apparatus 101. By the communication unit 156 enabling this access point, the communication apparatus 151 can operate as an access point. Note that the communication unit 156 may be directly wirelessly connected to the information processing apparatus 101 or wirelessly connected via the access point 131. In the present embodiment, the wireless communication scheme used by the communication unit 156 is a communication standard compliant with the IEEE 802.11 series. Also, in a case in which the communication apparatus 151 supports WEC, the WEC described above is performed via communications by the communication unit 156. Also, the communication unit 156 may be provided with hardware that functions as an access point or may operate as an access point via software for causing it to function as an access point.

The communication apparatus 151 of the present embodiment can operate in an infrastructure mode and a Peer to Peer (P2P) mode as the mode for communicating using the communication unit 156.

Infrastructure mode is a mode in which the communication apparatus 151 communicates with another apparatus such as the information processing apparatus 101 via an external apparatus (for example, the access point 131) that forms a network. Connection to an external access point established by the communication apparatus 151 operating in infrastructure mode is referred to as an infrastructure connection. In the present embodiment, with an infrastructure connection, the communication apparatus 151 operates as the subsidiary unit and the external access point operates as the main unit. Note that in the present embodiment, the main unit is an apparatus that sets the communication channel used by the network that the main unit belongs to, and the subsidiary unit is an apparatus that does not set the communication channel used by the network that the subsidiary unit belongs to and uses the communication channel set by the main unit.

P2P mode is a mode in which the communication apparatus 151 communicates directly with another apparatus such as the information processing apparatus 101 without using an external apparatus that forms a network. In the present embodiment, P2P mode includes AP mode in which the communication apparatus 151 operates as an access point. The connection information (SSID or password) of the access point enabled inside the communication apparatus 151 when in AP mode is able to be discretionarily set by the user. Note that P2P mode may also include, for example, WFD mode for the communication apparatus 151 to communicate via Wi-Fi Direct (WFD). Note that which of the plurality of WFD compatible devices operates as the main unit is determined in accordance with a sequence called the Group Owner Negotiation, for example. Note that the main unit may be determined without using the Group Owner Negotiation (hereinafter, abbreviated to GO Negotiation). A WFD compatible device that can function as the main unit is in particular referred to as a group owner. A direct connection to another apparatus established via the communication apparatus 151 operating in P2P mode is referred to as a direct connection. In the present embodiment, with a direct connection, the communication apparatus 151 operates as the main unit and another apparatus operates as the subsidiary unit.

The short distance wireless communication unit 157 is configured to wirelessly connect at short distances to an apparatus such as the information processing apparatus 101 and can connect to the short distance wireless communication unit 111 inside the information processing apparatus 101, for example. Examples of the communication scheme include, for example, NFC, Bluetooth Classic, BLE, Wi-Fi Aware, and the like.

The RAM 153 is constituted by an SRAM and the like that requires a backup power supply. Note that because the RAM 153 stores the data via a non-illustrated primary cell for data backup, the data required for program controlled variables and the like can be stored without volatilization. The RAM 153 is also provided with a memory area for storing setting information of the communication apparatus 151, management data of the communication apparatus 151, and the like. Also, the RAM 153 is used as the main memory and the working memory of the CPU 154 and stores a receiving buffer for temporarily storing the printing information received from the information processing apparatus 101 or the like and various types of information.

The ROM 152 stores fixed data, such as a control program executed by the CPU 154, data tables, an OS program, and the like. In the present embodiment, the respective control programs stored in the ROM 152 control the execution of software, such as scheduling, task switching, and interrupt processing, under the management of the built-in OS stored in the ROM 152. The CPU 154 is a system control unit that controls the entire communication apparatus 151.

An image is formed on a printing medium by providing a printing agent such as ink on a printing medium such as paper on the basis of information stored in the print engine 155, the RAM 153 or a print job received from the information processing apparatus 101, and the printing result is output. Note that typically, when the data amount of the print job transmitted from the information processing apparatus 101 or the like is large, a communication scheme capable of high speed communication is required to be used for communication of the print job. Thus, the communication apparatus 151 receives the print job via the communication unit 156, which is capable of communication at higher speeds than the short distance wireless communication unit 157. A display unit 161 is a panel, for example, that displays data and communicates the state of the communication apparatus 151.

Note that the communication apparatus 151 may be installed with a memory, such as an external HDD, SD card, or the like, as an optional device, and the information stored in the communication apparatus 151 may be stored on this memory.

In the present embodiment, the communication units 110 and 156 execute communication parameter sharing processing to share the communication parameters between the apparatuses. Communication parameter sharing processing is processing in which the apparatus on the providing side provides the communication parameters for wireless communication to the apparatus on the receiving side and may be executed in infrastructure mode and P2P mode, respectively. In this example, the communication parameters include, for example, a Service Set Identifier (SSID) as a network identifier, encryption method, encryption key, authentication method, authentication key, and other wireless communication parameters required for wireless LAN communication. Identification information such as a MAC address, a password, an IP address for IP-layer communication, and other information required to higher order services are also included. These wireless communication parameters used to connect to an access point may also be referred to as connection information. The communication parameter sharing processing executed by the communication units 110 and 156, for example, may be Wi-Fi Protected Setup (WPS) as specified by the Wi-Fi Alliance. Also, in the communication parameter sharing processing executed by the communication units 110 and 156, a method for transferring communication parameters safely using a public key encryption method may be used.

The communication apparatus 151 also includes a not-illustrated image code generation unit. Though not illustrated in FIG. 1, the image code generation unit is implemented by the CPU 154 executing a program. The image code generation unit generates an image code (code information), such as a barcode, a two-dimensional code, a QR code (registered trademark), or the like and performs control to display the generated image code on the display unit 161. The image code generation unit causes the display unit 161 to display a code image with encoded information required for communication parameter setup. Note that the display unit 161 may be configured to function as a user input interface and display software buttons and the like.

The operations of the communication system with the configuration described above will now be described. Hereinafter, processing will be described for performing transmitting control to switch between transmitting the specific signal or not for the information processing apparatus 101 to perform network setup of the communication apparatus 151 in a state in which the information processing apparatus 101 is not connected to an external access point.

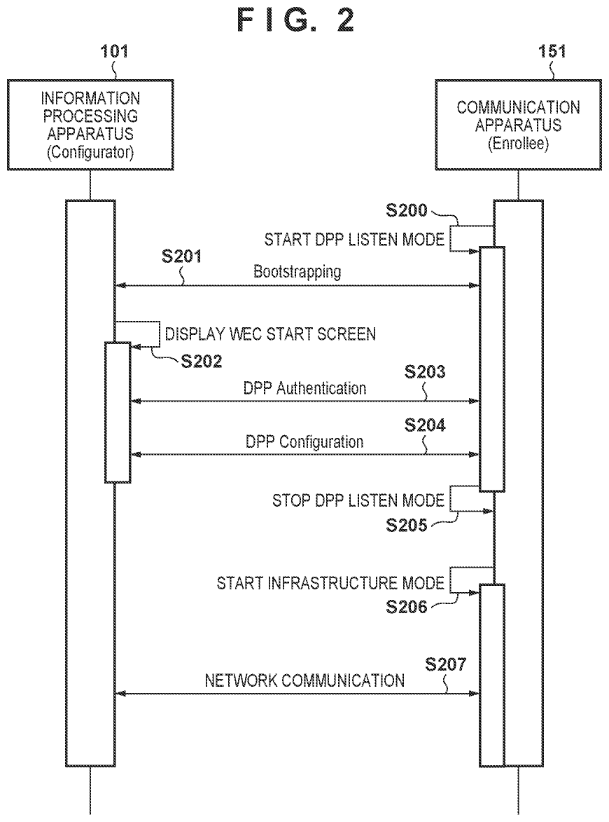

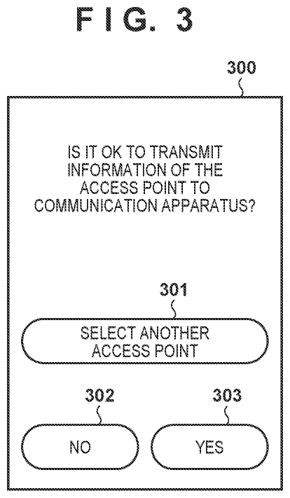

First, an example of network setup processing executed by the information processing apparatus 101 and the communication apparatus 151 via WEC using DPP will be described using FIGS. 2 and 3. The sequence illustrated in FIG. 2, for example, is implemented by the CPUs of the apparatuses reading out a program stored in the ROM of each apparatus or an external storage apparatus onto the RAM of each apparatus and executing the program.

First, in step S200, the communication apparatus 151 starts a DPP standby mode. The trigger for starting DPP standby mode may be a user operation via an operation unit 159 or a specific signal being received from an external apparatus such as the information processing apparatus 101 or the like. When the DPP standby mode is started, reading of WEC related information is enabled. For example, when using a code image such as a QR code (registered trademark) in the bootstrapping illustrated in step S201, the communication apparatus 151 generates a code image encoded with the WEC related information and displays the code image on the display unit 161.

In step S201, the information processing apparatus 101 obtains the WEC related information via the bootstrapping. For example, when using a code image in the bootstrapping, the information processing apparatus 101 executes a code image capture function via the setting application. With the code image capture function, the code image is captured using the imaging unit 112, the code image is parsed from the captured image, and the WEC related information, such as an encoded public key or the like, is obtained. In this manner, the WEC related information can be obtained by the setting application on the basis of the code image.

In step S202, WEC using DPP is started by the OS function of the information processing apparatus 101. Specifically, first, the information processing apparatus 101 starts up a WEC application via an instruction to start up the WEC application from the setting application to the OS. Accordingly, the WEC application runs in the foreground while the setting application is running in the background. Note that this instruction corresponds to an instruction to execute WEC, for example. Accordingly, the information processing apparatus 101 displays a WEC start screen via the WEC application. Note that the WEC application is a program installed in advance on the information processing apparatus 101 and is provided via the OS vendor of the information processing apparatus 101. Also, when the WEC application is started up, the WEC related information obtained via the setting application is provided to the WEC application.

FIG. 3 is an example of the WEC start screen displayed by the WEC application. On a WEC start screen 300, regions 301, 302, and 303 are displayed. The region 301 is a region for changing the access point set as the setting target for WEC. Note that before the region 301 is operated, the access point set as the setting target for WEC is the access point that the information processing apparatus 101 is currently connected to. When the region 301 is selected, the information processing apparatus 101 displays a list of access points and sets the access point selected by the user from the list as the new setting target for WEC. Note that the list of access points includes the access points that the information processing apparatus 101 has connected to and the like. The region 302 is a region for canceling execution of WEC, and the region 303 is a region for instructing for the execution of WEC.

When the region 302 is operated, the information processing apparatus 101 ends the processing in the present sequence diagram. When the region 303 is pressed, the information processing apparatus 101 advances the processing to step S203. However, in another example, the display in FIG. 3 may be not provided, and the processing may proceed to step S203 without the region 303 being pressed. In step S203, the WEC application executes the API for WEC using the WEC related information and information relating to the access point set as the setting target for WEC to instruct the OS to execute WEC. Then, via the OS function, authentication request processing referred to as DPP authentication is executed between the information processing apparatus 101 and the communication apparatus 151.

In DPP authentication, authentication of the communication between the apparatuses is performed by authentication information, information used to encrypt information, and the like being communicated between the information processing apparatus 101 and the communication apparatus 151. Note that the various types of information transmitted from the information processing apparatus 101 in the DPP authentication communications are encrypted on the basis of a public key included in the WEC related information obtained from the communication apparatus 151 by the information processing apparatus 101. In the DPP authentication, specifically, first, the information processing apparatus 101 transmits Authentication Request as an authentication request.

Next, since the communication apparatus 151 operating in DPP standby mode is operating in DPP standby mode, which is a mode for waiting for an authentication request, the communication apparatus 151 receives the request transmitted from the information processing apparatus 101. After receiving the authentication request, the communication apparatus 151 attempts to decrypt the received authentication request using the decryption key currently in possession. Then, when decryption is successful, the communication apparatus 151 transmits Authentication Response as an authentication response to the information processing apparatus 101 and authenticates communication with the information processing apparatus 101. Note that when the information processing apparatus 101 cannot obtain accurate WEC related information with the information being not accurately encrypted, the decryption by the communication apparatus 151 fails. Thus, authentication fails, and an authentication response is not transmitted. When an authentication response is received by the information processing apparatus 101, the DPP authentication is complete. Also, in the DPP authentication, communication is performed using DPP.

Next, in step S204, via the OS function, processing referred to as DPP configuration is executed between the information processing apparatus 101 and the communication apparatus 151. In the DPP configuration, the information processing apparatus 101 transmits connection information for connecting to the access point set as the setting target for WEC to the communication apparatus 151 using WEC. Note that the connection information includes at least one of the SSID and password for the access point set as the setting target for WEC, information indicating the encryption method, or the like. The password transmitted at this time is information input by a user on a screen displayed by an OS-supported application when connection is established between the information processing apparatus 101 and the access point. Also, the password to be transmitted is information stored by the OS when connection is established between the information processing apparatus 101 and the access point. Also, the password is information not stored by the setting application. Furthermore, the password to be transmitted at this time is information already stored by the OS, and, since DPP configuration is processing executed by the OS, there is no need for the user to newly input the password on the screen displayed by the setting application.

Since the connection information is transmitted using WEC as according to the present embodiment, the password can be transmitted, via secure communication, to the communication apparatus 151 without newly receiving password input from the user on the screen displayed by the setting application. Note that in DPP configuration also, communication is performed using DPP.

In step S205, the communication apparatus 151 ends the DPP standby mode in response to the DPP configuration ending.

In step S206, the communication apparatus 151 transitions to infrastructure mode, with the connection information having been obtained via DPP configuration. Then, the communication apparatus 151 attempts to connect to the access point corresponding to the connection information using the connection information. When connection is successful, thereafter, the communication apparatus 151 can communicate via the network formed by the connected access point. Note that the communication via the network formed by the connected access point is performed using a protocol (specifically, for example, Port 9100, SNMP, HTTP, or a protocol unique to the vendor of the communication apparatus 151) different from DPP.

Note that the communication apparatus 151 may transmit, to the information processing apparatus 101, information indicating connection success or failure with the access point corresponding to the connection information obtained via WEC. Also, when connection fails with the access point corresponding to the connection information obtained via WEC, information indicating the cause of failure may be transmitted to the information processing apparatus 101. The transmission of information may be performed using DPP. Examples of the cause of connection failure with the access point corresponding to the connection information obtained via WEC include an error in WEC communication, the access point being unable to be found, the WEC related information obtained from the communication apparatus 151 being not appropriate, and the like. Another example of the cause of connection failure with the access point includes the encryption method used when connecting to the access point set as the setting target for WEC being an encryption method not supported by the communication apparatus 151. Yet another includes the encryption method used when connecting to the access point set as the setting target for WEC being an encryption method not supported by WEC. Note that the information processing apparatus 101 may display, on the display unit 108, information indicating connection success or failure between the communication apparatus 151 and the access point corresponding to the connection information obtained via WEC. Also, when connection fails between the communication apparatus 151 and the access point corresponding to the connection information obtained via WEC, information indicating the cause of failure may be displayed on the display unit 108.

In step S207, the information processing apparatus 101 switches the application running in the foreground from the WEC application to the setting application on the basis of execution of WEC being complete. Also, the information processing apparatus 101 searches for the communication apparatus 151 on the network the information processing apparatus 101 belongs to. The present processing is implemented by the setting application receiving a notification that execution of WEC is complete from the OS. Then, when the communication apparatus 151 is found, the information processing apparatus 101 performs a query to request for capability information from the communication apparatus 151. The communication apparatus 151 performs a response to transmit the capability information to the information processing apparatus 101. In this manner, in the setting application, the information of the communication apparatus 151 is registered, enabling communication with the communication apparatus 151 to be performed via the setting application thereafter. Specifically, for example, a print job can be transmitted to the communication apparatus 151 via the setting application.

Note that at this time, when the information processing apparatus 101 belongs to the network formed by the access point that the communication apparatus 151 is connected to via WEC, communication with the communication apparatus 151 via the access point can be performed. Also, when communication between the information processing apparatus 101 and the communication apparatus 151 cannot be performed, for example when the access point that the communication apparatus 151 is connected to is not the access point that the information processing apparatus 101 is connected to or the like, requesting and obtaining the capability information is omitted. Note that the communication in step S207 can be performed using a communication protocol that is different from DPP and the communication protocol for setup. Thereafter, the information processing apparatus 101 ends the processing of the present sequence.

Note that as described above, the WEC start screen is displayed by the WEC application, and the OS is instructed to execute WEC by the WEC application executing the API for WEC. However, no such limitation is intended. For example, the WEC start screen may be displayed by the setting application, for example. Also, by the setting application executing the API for WEC, the OS may be instructed to execute WEC.

Also, as described above, a method using a code image is used as the bootstrapping method. However, no such limitation is intended. For example, for the bootstrapping method, short distance wireless communication, such as NFC or BLE, may be used. Also, in another example, communication using a communication protocol, such as SNMP or HTTP, via the access point for setup operating in DPP standby mode may be used.

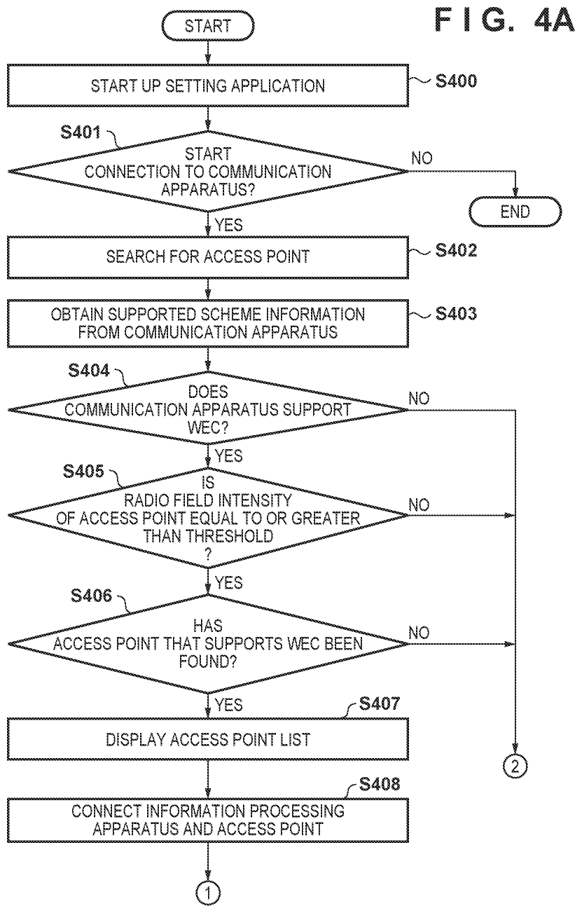

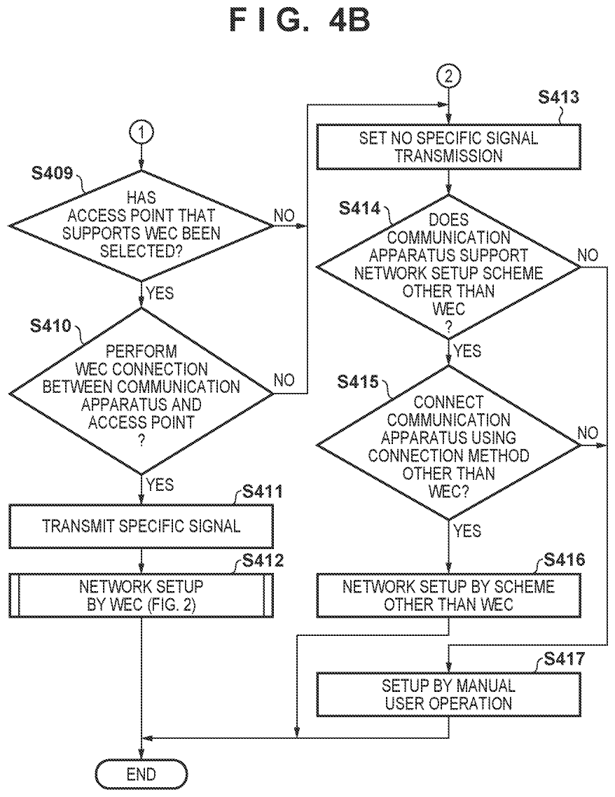

Next, a processing sequence for transmission control to control whether or not to transmit the specific signal to the communication apparatus 151 which is started when the information processing apparatus 101 is not connected to an access point will be described using FIGS. 4, 5A to 5D, and 7.

FIGS. 4A and 4B are a flowchart illustrating connection processing executed by the information processing apparatus 101 which is not connected to an access point. The processing illustrated in the flowchart of FIGS. 4A and 4B is started on the basis of a user operating the information processing apparatus 101 and instructing the information processing apparatus 101 to start up the setting application. Also, the processing illustrated in FIGS. 4A and 4B is, for example, implemented by the CPU 103 loading the setting application stored in the ROM 104, the memory, or the like on the RAM 105 and executing the setting application. In the example described below, the processing illustrated in FIGS. 4A and 4B is executed by the setting application, but in another example, the processing may be implemented by a combination of software and hardware of the information processing apparatus 101, such as another application executed by the information processing apparatus 101, the communication unit 110, and the like.

In step S400, the information processing apparatus 101 starts up the setting application in response to a user operation. In step S401, the setting application displays a screen for whether or not to perform connection of the information processing apparatus 101 and the communication apparatus 151 on the display unit 108 of the information processing apparatus 101. Then, the setting application determines whether or not to start connection to the communication apparatus 151. Note that the connection to the communication apparatus 151 at this time is to perform network setup for the communication apparatus 151.

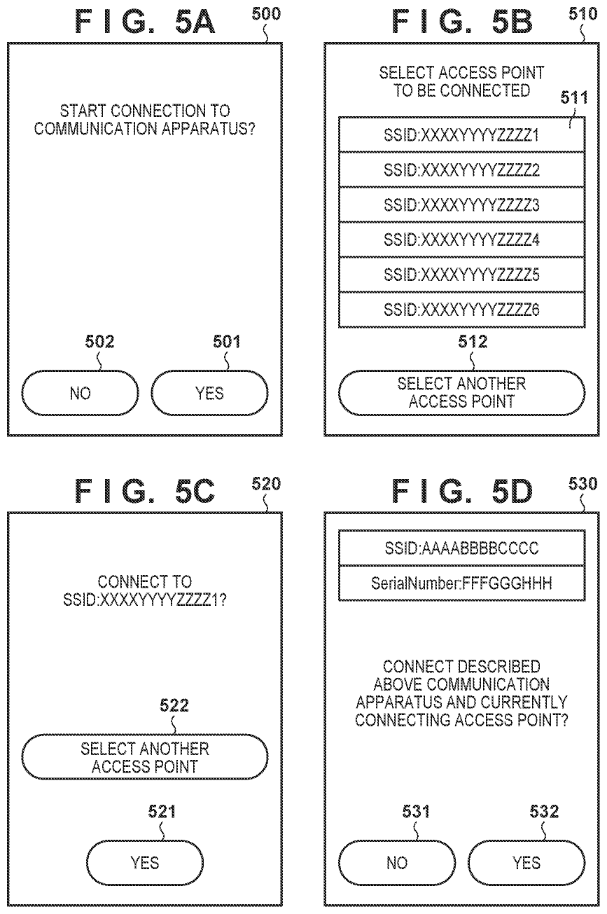

FIG. 5A illustrates an example of a start screen for connecting to the communication apparatus 151 displayed on the display unit 108 via the setting application. On a connection start screen 500, a region 501 and a region 502 are displayed. The region 501 is a region for receiving an instruction to start processing to connect to the communication apparatus 151. The region 502 is a region for receiving an instruction to not start processing to connect to the communication apparatus 151.

In step S401, when the region 502 being pressed is detected (No in step S401), the information processing apparatus 101 ends the processing illustrated in FIGS. 4A and 4B without transmitting the specific signal to the communication apparatus 151. On the other hand, in step S401, when the region 501 for starting the connection processing being pressed is detected by the setting application (Yes in step S401), the information processing apparatus 101 advances the processing to step S402. In step S402, the setting application executes search processing for an access point and searches for access points present near the information processing apparatus 101. Here, the search processing for an access point is a passive scan that waits for network information to be communicated from an access point or an active scan that transmits a probe request signal to an access point and obtains network information.

Subsequently, in step S403, the setting application obtains supported scheme information relating to the network setup scheme supported by the communication apparatus 151. The supported scheme information includes information such as a specific character string indicating the supported network setup scheme, such as WEC, Wi-Fi Direct, or the like. In this case, when the communication apparatus 151 supports a plurality of schemes, the supported scheme information may include information indicating a plurality of schemes. In another example, the supported scheme information may include a flag indicating whether or not the communication apparatus 151 supports a specific network setup scheme such as WEC. For example, the supported scheme information may include a plurality of flags indicating whether or not each network setup scheme is supported.

The following are four examples of the information processing apparatus 101 obtaining the supported scheme information of the communication apparatus 151.

In the first example, the communication apparatus 151 operates in AP mode and transmits a beacon including the identifier of the communication apparatus 151 and the supported scheme information to the SSID of the access point. In this case, the information processing apparatus 101 can determine the network setup scheme supported by the communication apparatus 151 for setup on the basis of the SSID of the access point detected in step S402.

In the second example, the identifier of the communication apparatus 151 is included in the SSID of the access point detected in step S402, and the supported scheme information of the communication apparatus 151 is included in a probe response signal, which is a response to a probe request. In this case, the information processing apparatus 101 identifies the communication apparatus 151 on the basis of the SSID of the access point detected in step S402. Then, by transmitting a probe request signal in step S403 and receiving a probe response signal including the supported scheme information, the information processing apparatus 101 can determine the network setup scheme supported by the communication apparatus 151.

In the third example, to obtain the supported scheme information from the communication apparatus 151, the information processing apparatus 101 establishes a connection different from the connection used in the network setup and obtains the supported scheme information from the communication apparatus 151 via the established connection. For example, the information processing apparatus 101 can perform direct wireless connection between the information processing apparatus 101 and the communication apparatus 151 and obtain the supported scheme information relating to the network setup scheme supported by the communication apparatus 151.

In the fourth example, the information processing apparatus 101 uses the information stored in the storage unit and determines the network setup scheme supported by the communication apparatus 151. For example, the information processing apparatus 101 stores information relating to the network setup scheme supported by the communication apparatus 151 in a storage unit of the external storage apparatus 106 or the like for each communication apparatus 151 it has previously connected to. The information processing apparatus 101 identifies the communication apparatus 151 on the basis of the SSID detected in step S402 and obtains the supported scheme information of the identified communication apparatus 151 from the storage unit. Accordingly, the information processing apparatus 101 can determine the network setup scheme supported by the communication apparatus 151.

Subsequently, in step S404, when the setting application determines that the communication apparatus 151 does not support WEC, the setting application does not transmit the specific signal (step S413). Then, in step S414, the setting application determines whether or not the communication apparatus 151 supports a network setup scheme other than WEC. When the setting application determines that the communication apparatus 151 does not support a network setup scheme other than WEC (No in step S414), the setting application advances the processing to step S417 and instructs the user to perform the network setup (manual setup) via manual setup. Here, manual setup refers to the user directly operating the communication apparatus 151 and connecting to an access point other than the communication apparatus 151. The information processing apparatus 101 may display a screen to the user for a manual setup execution instruction. Also, the setting application may transmit an instruction signal for displaying an input screen for manual setup to the communication apparatus 151. Accordingly, the communication apparatus 151 can quickly switch to manual setup processing.

When the setting application determines that the communication apparatus 151 does support a network setup scheme other than WEC (Yes in step S414), the setting application advances the processing to step S415. In step S415, the setting application displays, on the information processing apparatus 101, a selection for whether to perform network setup using a scheme other than WEC and allows the user to select. At this time, when the user rejects network setup using a scheme other than WEC, in step S417, the user is instructed to execute network setup via manual setup. Also, in step S415, when the user selects to execute network setup using a scheme other than WEC, in step S416, the information processing apparatus 101 executes network setup processing with the communication apparatus 151 using the scheme other than WEC. The network setup scheme other than WEC, for example, is a scheme using a direct connection in which the information processing apparatus 101 and the communication apparatus 151 directly connect, such as Wi-Fi Direct (WFD) or μAP. According to these schemes, using a direct connection, specific information used for the communication apparatus 151 to connect to an access point other than the communication apparatus 151 is transmitted from the information processing apparatus 101. In addition to the schemes described above, another connection scheme such as Bluetooth Low Energy (BLE) or the like may be used for direct connection.

When it is determined that the communication apparatus 151 supports WEC, in step S405, the setting application determines whether or not a radio field intensity of the access point detected as the result of the access point search is equal to or greater than a threshold. Note that a specific example of radio field intensity is Signal Noise Ratio (SNR). In step S405, when the radio field intensity is determined to be not equal to or greater than the threshold, in step S413, the information processing apparatus 101 does not transmit the specific signal. Then, in steps S414 and S415, the setting application executes network setup processing via a scheme other than WEC according to a user selection or executes setup processing (manual setup processing) according to a manual operation by the user.

On the other hand, when the radio field intensity of the access point is determined to be equal to or greater than the threshold, the information processing apparatus 101 advances the processing to step S406 and determines whether or not an access point that supports WEC has been detected. For example, the determination of step S404 may be performed on the basis of whether or not information indicating the DPP is included in the beacon advertised by the access point in step S402 or an AKM of a probe response. Note that AKM is an abbreviation of Authentication and Key Management. In step S406, when the detected access point is determined to not support WEC, in step S413, the specific signal is set to not be transmitted. Then, in steps S414 and S415, depending on the determination, the setting application instructs to execute network setup processing via a scheme other than WEC according to a user selection or network setup processing according to manual operation by the user.

On the other hand, in step S406, when WEC-supported access points are found, then in step S407, the setting application displays a screen of the list of access points. FIG. 5B illustrates an example of an access point list screen displayed by the setting application. On an access point list screen 510, a region 511 and a region 512 are displayed. The region 511 is a region for receiving an instruction to start network setup for connecting the access point and the communication apparatus 151 and displays a list of access point SSIDs. When one of the SSIDs of the region 511 is selected, network setup processing to connect the access point and the communication apparatus 151 is started.

Here, to make it easier for the user to select a WEC-supported access point, WEC-supported access points are displayed on the top of the SSIDs (SSID: XXXXYYYYZZZZ1) in the region 511. Also, these may be identified by the word “recommended” being displayed with the SSID of WEC-supported access points, the SSID character string may be colored, or the like. In this manner, the access points that support WEC can be made easier to select. In other words, the unintentional selection of an access points that does not support WEC can be prevented. Note that when the region of the region 512 is selected, specifying of an access point not displayed in the list of the region 511 can be received. For example, access points not displayed in the list of the region 511 may be displayed or an access point search may be performed again and the search results may be displayed. In other words, the region 512 is a region for receiving an instruction to start network setup of the communication apparatus 151 via an access point other than an access point displayed in the region 511.

Also, to make it easier for an access point that supports WEC to be selected, an access point connection confirmation screen 520 in FIG. 5C may be displayed instead of the screen in FIG. 5B. A region 521 is a region for receiving an instruction to connect to the access point of the displayed SSID. A region 522 is a region for receiving the specification of another access point that is not displayed. When the region 521 is pressed, processing to connect the access point of the displayed SSID and the information processing apparatus 101 is started. When the region 522 is pressed, access points that are not displayed may be displayed or other access points that support WEC may be displayed. Alternatively, an access point search may be performed again, and access points that support WEC that are different from the displayed access points may be displayed.

Subsequently, in step S408, the setting application connects the information processing apparatus 101 and the access point selected in step S407. Note that the setup scheme may be a scheme other than WEC. At this time, to connect the access point and the information processing apparatus 101, the user may be made to input the password for the access point into the information processing apparatus 101.

Subsequently, in step S409, the setting application determines whether or not an access point that supports WEC has been selected in step S407. In this example, this is determined on the basis of the selected access point, but a different method of determination may be used. For example, this may be determined on the basis of whether or not the access point connected in step S408 supports WEC.

In step S409, when it is determined that an access point that supports WEC has not been selected (No in step S409), the setting application advances the processing to step S413 and the specific signal is set to not be transmitted. Then, the setting application executes network setup processing using a scheme other than WEC according to the user selection in steps S414 and S415.

On the other hand, when it is determined that an access point that supports WEC has been selected (Yes in step S409), the setting application advances the processing to step S410 and a screen for confirming the connection between the communication apparatus 151 and the access point is displayed. FIG. 5D illustrates an example of a connection confirmation screen displayed by the setting application. On a connection confirmation screen 530, a region 531, a region 532, the SSID of the communication apparatus 151, and the serial number of the communication apparatus 151 are displayed. The region 531 is a region for receiving an instruction to not execute processing to connect the access point and the communication apparatus 151 using the WEC network setup scheme. The region 532 is a region for receiving an instruction to execute processing to connect the access point and the communication apparatus 151 using the WEC network setup scheme.

When the region 531 is pressed, the setting application advances the processing to step S413, the specific signal is set to not be transmitted, and connection processing using a setup scheme other than WEC is executed according to steps S414 and S415. Note that the SSID of the communication apparatus 151 displayed on the connection confirmation screen 530 is the SSID of the communication apparatus 151 detected in the access point search in step S402 and determined to support WEC in step S404, for example. Also, the displayed serial number of the communication apparatus 151 is a serial number included in the capability of the communication apparatus 151 obtained by the information processing apparatus 101 as described above, for example. Also, instead of a serial number, a MAC address may be used. When a MAC address is used, for example, the MAC address may be obtained from a beacon obtained in the access point search of step S402 or from a BSSID included in a probe response. By the serial number being displayed, the user can be made aware that the specific signal is to be transmitted to the intended apparatus. Also, on the connection confirmation screen 530, the serial number may be not displayed.

When the region 532 is pressed, in step S411, the setting application transmits the specific signal to the communication apparatus 151. When the region 532 is pressed, in step S411, the setting application starts network setup processing using the WEC for the communication apparatus 151. First, the setting application transmits the specific signal to the communication apparatus 151. The specific signal according to the present embodiment is, for example, a service discovery request of the WFD scheme or a probe request (specifying the SSID of the communication apparatus 151).

As illustrated in FIG. 2, in step S412, the information processing apparatus 101 executes network setup processing using WEC for the communication apparatus 151. In other words, as illustrated in FIG. 2, when the communication apparatus 151 receives the specific signal, the communication apparatus 151 starts the DPP standby mode and displays a code image. Thereafter, the information processing apparatus 101 ends the processing illustrated in FIGS. 4A and 4B. Note that in steps S401, S404, S405, S406, S409, and S410 described above, a sequence is performed in which determination processing is executed and whether or not transmit the specific signal is determined depending on the determination result. However, configuration may be such that a part of this determination processing may is executed. Also, in the sequence described above, in steps S414 and S415, network setup processing using a scheme other than WEC is executed. However, configuration may be such that a part of this determination processing is not be executed. For example, when the communication apparatus 151 does not support WEC, the processing illustrated in FIGS. 4A and 4B may be changed to instruct network setup processing to be executed according to a manual operation. Also, each item of processing in FIGS. 4A and 4B described above is executed by an instruction from the setting application. However, instead of the setting application, the processing may be executed by an instruction from the WEC application or may be executed by an instruction from the OS.

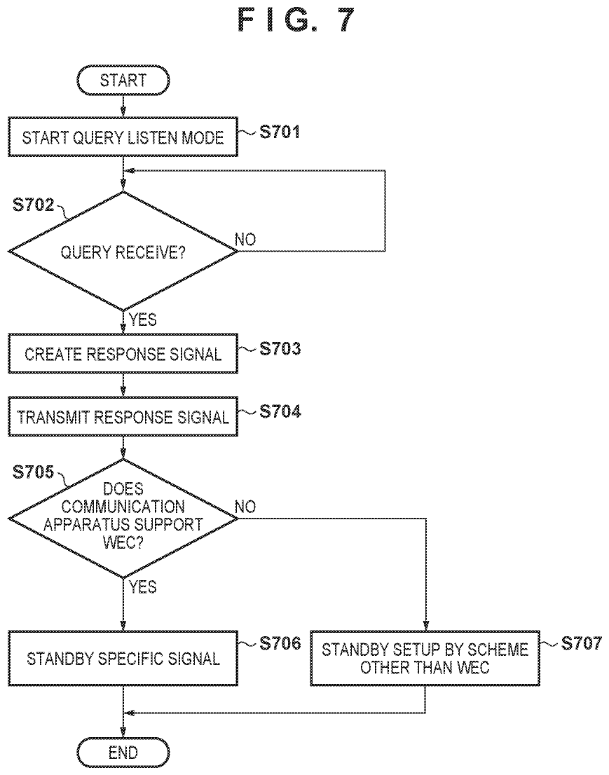

FIG. 7 is a flowchart illustrating an example of processing until the communication apparatus 151 starts the DPP standby mode. The flowchart illustrated in FIG. 7 is implemented by the setting application stored in the ROM 152 or the memory being read out onto the RAM 153 and executed by the CPU 154 of the communication apparatus 151, for example. Also, the flowchart in FIG. 7 is started on the basis of an instruction to start network setup being received by the communication apparatus 151, for example. Note that in the example in FIG. 7, in step S403, the information processing apparatus 101 transmits a probe request to the communication apparatus 151, and a probe response signal including the supported scheme information relating to the network setup scheme supported by the communication apparatus 151 is received. In other words, of the four examples in which the supported scheme information of the communication apparatus 151 is obtained by the information processing apparatus 101 described in relation to step S403, the second example will be used in the following description.

In step S701, the communication apparatus 151 starts a standby mode for a query signal. Here, the query signal is a probe request signal transmitted from the information processing apparatus 101. For example, the communication apparatus 151 waits for a query signal in the standby mode for a predetermined length of time.

In step S702, the communication apparatus 151 determines whether or not a query signal has been received. When a query signal has been received (Yes in step S702), the communication apparatus 151 advances the processing to step S703. In step S703, the communication apparatus 151 generates a response signal including the supported scheme information. In other words, the communication apparatus 151 generates a response signal including information that allows whether or not the communication apparatus 151 supports a WEC network setup to be determined. In the example in FIG. 7, the response signal is a probe response signal. Subsequently, the communication apparatus 151 advances the processing to step S704 and transmits the response signal generated in step S703 to the information processing apparatus 101. On the basis of the response signal transmitted in step S704, the information processing apparatus 101 can obtain information that allows whether or not the communication apparatus 151 supports a WEC network setup to be determined.

Subsequently, the communication apparatus 151 advances the processing to step S705. When the communication apparatus 151 supports a WEC network setup (Yes in step S705), the communication apparatus 151 advances the processing to step S706 and starts standby for the specific signal. The specific signal may be a DPP probe request signal as described above. When the specific signal is received by the communication apparatus 151, DPP standby mode is started, and network setup processing using WEC can be executed as illustrated in FIG. 2.

When the communication apparatus 151 does not support a WEC network setup (No in step S705), the communication apparatus 151 advances the processing to step S707 and sets specific signal standby to not be performed. For example, standby for a start request of another setup scheme such as Wi-Fi Protected Setup (WPS) may be performed.

As described above, according to the present embodiment, when the communication apparatus 151 does not support a WEC network setup, the information processing apparatus 101 does not transmit the specific signal to the communication apparatus 151. This can prevent network setup processing failure in which the specific signal is transmitted to the communication apparatus 151 by the information processing apparatus 101 and no response is received due to the communication apparatus 151 not supporting WEC. Accordingly, an unnecessary increase to the length of time taken for the network setup processing of the communication apparatus 151 can be suppressed, and consumption of network bandwidth due to the unnecessary transmission of the specific signal can be suppressed. Also, the information processing apparatus 101 executing network setup processing using the WEC scheme for the communication apparatus and transmitting the specific signal can be prevented when a communication apparatus that does not support WEC and another apparatus that supports WEC are present. This can prevent an apparatus unintended by the user, the other apparatus that supports WEC in the example described above, from reacting and operating in a manner unintended by the user.

Note that in the example in FIG. 4A, in step S403, the information processing apparatus 101 identifies the network setup scheme that the communication apparatus 151 supports from the obtained information. However, the information processing apparatus 101 may determine only whether or not the communication apparatus 151 supports a specific network setup scheme such as WEC. In this case, configuration may be such that in step S414 in FIG. 4B, the information processing apparatus 101 does not determine whether or not the communication apparatus 151 supports network setup schemes other than WEC. In such a case, after step S413, the information processing apparatus 101 may advance the processing to the network setup (step S417) via manual setup by the user.

### Second Embodiment

The differences of the second embodiment with respect to the first embodiment will be focused on and described below. In the first embodiment, control is performed so that when the information processing apparatus 101 is in a non-connected state with an external access point, the processing in FIGS. 4A and 4B is started, and processing to transmit the specific signal to the communication apparatus 151 and processing to not transmit the specific signal is switched between. In the second embodiment, processing is started so that control is performed to switch between the two types of processing described above when the information processing apparatus 101 is in a connected state with an external access point.

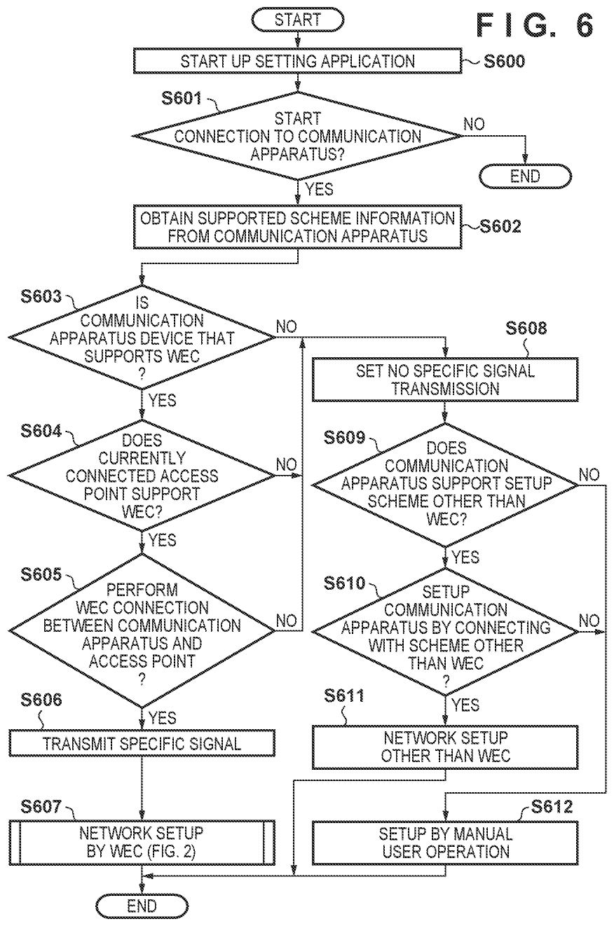

FIG. 6 is a flowchart illustrating the processing to control transmission of the specific signal according to the present embodiment. The processing in FIG. 6 is implemented by the CPU 103 reading out a program stored in the ROM 104 onto the RAM 105 and executing the program, for example.

In step S600, the information processing apparatus 101 starts up the setting application of the information processing apparatus 101 in response to a user operation. In step S601, the setting application display a screen for receiving an instruction as to whether or not to connect the information processing apparatus 101 and the communication apparatus 151. In step S601, as in the first embodiment, the connection start screen 500 in FIG. 5A is displayed. Then, the setting application determines whether or not to start network setup for the communication apparatus 151. In step S601, when the region 502 being pressed is detected, the setting application determines to not execute network setup processing for the communication apparatus 151. Then, the processing in FIG. 6 ends without the specific signal being transmitted from the information processing apparatus 101. On the other hand, when the region 501 being pressed is detected, the setting application advances the processing to step S602.

In step S602, the setting application obtains the supported scheme information from the communication apparatus 151. This is as described for step S403 in FIG. 4A, and thus description thereof will be omitted. Note that in FIGS. 4A and 4B, the access point search is performed before the determination of step S403, but the information processing apparatus 101 according to the present embodiment uses the currently connected access point in the network setup for the communication apparatus 151. Thus, the information processing apparatus 101 does not perform an access point search before the determination of step S602. However, an access point search may be performed before step S602, and, as in step S403, the search result may be used to determine whether or not the communication apparatus 151 supports a specific setup scheme.

Subsequently, in step S603, whether or not the communication apparatus 151 supports WEC is determined from the supported scheme information obtained in step S602. This is as described for step S404 in FIG. 4A, and thus description thereof will be omitted. When the communication apparatus 151 does not support WEC network setup, in step S608, the specific signal is set to not be transmitted.

Then, in step S609, the setting application determines whether or not the communication apparatus 151 supports a network setup using a scheme other than WEC. When a setup scheme other than WEC is not supported, in step S612, the setting application instructs the user to setup via manual operation. Also, in step S609, when a setup scheme other than WEC is supported, in step S610, a screen querying the user as to whether or not to setup using the scheme other than WEC is displayed on the information processing apparatus 101, and user input is waited for. At this time, when a user instruction to not performing network setup using the scheme other than WEC is received, in step S612, the user is instructed to execute setup via manual operation. Also, in step S610, when a user instruction to execute network setup using a scheme other than WEC is received, in step S611, the information processing apparatus 101 executes network setup for the communication apparatus 151 using the scheme other than WEC.

Subsequently, in step S604, the setting application determines whether or not the access point that the information processing apparatus 101 is currently connected to is an access point that supports WEC. For example, the determination of step S604 may be performed on the basis of whether or not the DPP is included in the beacon previously advertised by the connected access point or an AKM of a probe response. Also, in the determination of step S604, information stored in the non-volatile memory of the information processing apparatus 101 may be used. Furthermore, though not illustrated in FIG. 6, communication with the currently connected access point may be performed to obtain an AKM, and the determination of step S604 may be performed on the basis of the obtained information.

When it is determined that the access point that the information processing apparatus 101 is currently connected to does not support WEC (No in step S604), the setting application sets the specific signal to not be transmitted in step S608 and performs network setup using a scheme other than WEC in steps S609 and S610. The network setup using a scheme other than WEC may be performed using an infrastructure connection via an access point or using a direct connection bypassing an access point. Also, the processing after step S402 in FIG. 4A may be executed, an access point that supports WEC different from the currently connected access point may be searched for, and network setup using WEC may be performed via the access point that supports WEC. In this manner, network setup using WEC can be prioritized over network setup using a different scheme.

In step S604, when it is determined that the currently connected access point supports WEC (Yes in step S604), the setting application advances the processing to step S605 and a screen for confirming the connection between the communication apparatus 151 and the access point is displayed. In step S605, as in the first embodiment, the connection confirmation screen 530 in FIG. 5D is displayed.

Also, the subsequent processing of steps S606 and S607 are similar to the processing of steps S411 and S412 in FIG. 4B, and thus description thereof will be omitted.

As described above, according to the present embodiment, when the communication apparatus 151 does not support WEC, the specific signal is not transmitted to the communication apparatus 151. In this manner, the information processing apparatus 101 transmitting the specific signal to the communication apparatus 151 regardless of whether or not network setup can be performed using WEC can be prevented.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-096758, filed Jun. 15, 2022, which is hereby incorporated by reference herein in its entirety.

What is claimed is:

1. A non-transitory computer-readable storage medium storing a program for causing a computer of an information processing apparatus that can wirelessly communicate with a communication apparatus to function as:
a first obtaining unit configured to obtain supported scheme information relating to a setup scheme supported by the communication apparatus; and
a transmission control unit configured to control the information processing apparatus to transmit to the communication apparatus a specific signal for enabling network setup using a first scheme for connecting the communication apparatus to an access point other than the communication apparatus,
wherein the transmission control unit controls the information processing apparatus to:
transmit the specific signal to the communication apparatus when the supported scheme information indicates that the communication apparatus supports network setup using the first scheme; and
not transmit the specific signal when the supported scheme information indicates that the communication apparatus does not support network setup using the first scheme.

2. The non-transitory computer-readable storage medium according to claim 1, wherein the transmission control unit transmits the specific signal when the supported scheme information indicates that the communication apparatus supports network setup using a plurality of schemes including the first scheme.

3. The non-transitory computer-readable storage medium according to claim 1, wherein the program further causes the computer of the information processing apparatus to function as:
a display unit configured to display a selection of whether or not to connect the communication apparatus to the access point via network setup using a second scheme different from the first scheme when the supported scheme information indicates that the communication apparatus does not support network setup using the first scheme and indicates that the communication apparatus supports network setup using the second scheme.

4. The non-transitory computer-readable storage medium according to claim 3, wherein
the display unit displays a screen for receiving selection of whether or not to perform network setup manually when to not perform network setup using the second scheme is selected from a selection displayed by the display unit of whether or not to connect the communication apparatus to the access point via network setup using the second scheme, and
the transmission control unit controls the information processing apparatus to transmit an instruction signal to cause the communication apparatus to display an input screen for manual setup when manual network setup is selected.

5. The non-transitory computer-readable storage medium according to claim 1, wherein the program further causes the computer of the information processing apparatus to function as:
a second obtaining configured to obtain second supported scheme information relating to a setup scheme supported by the access point, and
the transmission control unit controls the information processing apparatus to transmit the specific signal when the supported scheme information indicates that the communication apparatus supports network setup using the first scheme and the second supported scheme information indicates that the access point supports network setup using the first scheme.

6. The non-transitory computer-readable storage medium according to claim 1, wherein the first scheme is Wi-Fi Easy Connect.

7. The non-transitory computer-readable storage medium storing a program according to claim 1, wherein the program further causes the computer of the information processing apparatus to function as:
a second obtaining unit configured to obtain specific information obtained using a public key output from the communication apparatus when the specific signal is transmitted;
a first transmitting unit configured to transmit an authentication request used by the public key after the specific information is obtained by the second obtaining unit;
a receiving unit configured to receive, from the communication apparatus, an authentication response to the authentication request transmitted by the first transmitting unit; and
a second transmitting unit configured to transmit, to the communication apparatus, connection information used to establish a wireless connection between the communication apparatus and the access point after the authentication response is received by the receiving unit.

8. The non-transitory computer-readable storage medium according to claim 7, wherein
the specific information is a code image obtained by encoding the public key, and
the second obtaining unit obtains the specific information from the code image captured by an imaging unit of the information processing apparatus.

9. The non-transitory computer-readable storage medium according to claim 1, wherein the first obtaining unit obtains the supported scheme information by a first signal querying the supported scheme information relating to a setup scheme supported by the communication apparatus being transmitted to the communication apparatus and a response including the supported scheme information relating to a setup scheme supported by the communication apparatus being received from the communication apparatus as a response to the first signal.

10. A control method of an information processing apparatus that can wirelessly communicate with a communication apparatus comprising:
obtaining supported scheme information relating to a network setup scheme supported by the communication apparatus; and
controlling the information processing apparatus to transmit to the communication apparatus a specific signal for enabling network setup using a first scheme for connecting the communication apparatus to an access point other than the communication apparatus,
wherein the specific signal is transmitted to the communication apparatus when the supported scheme information indicates that the communication apparatus supports network setup using the first scheme, and
wherein the specific signal is not transmitted when the supported scheme information indicates that the communication apparatus does not support network setup using the first scheme.

11. A communication apparatus that can wirelessly communicate with an information processing apparatus comprising:
a receiving unit configured to receive a first signal querying supported scheme information relating to a network setup scheme supported by the communication apparatus from the information processing apparatus;
a transmitting unit configured to transmit a response including the supported scheme information as a response to the first signal received by the receiving unit; and
a standby unit configured to wait for a specific signal for enabling network setup using a first scheme for connecting the communication apparatus to an access point other than the communication apparatus when the response is transmitted by the transmitting unit.

12. A non-transitory computer-readable storage medium storing a program, wherein the program causes a computer of a communication apparatus that can wirelessly communicate with an information processing apparatus to function as:
a receiving unit configured to receive a first signal querying supported scheme information relating to a network setup scheme supported by the communication apparatus from the information processing apparatus;
a transmitting unit configured to transmit a response including the supported scheme information as a response to the first signal received by the receiving unit; and
a standby unit configured to wait for a specific signal for enabling network setup using a first scheme for connecting the communication apparatus to an access point other than the communication apparatus when the response is transmitted by the transmitting unit.

13. A communication system comprising:
a communication apparatus; and
an information processing apparatus that can wirelessly communicate with the communication apparatus, wherein
the information processing apparatus includes:
a first obtaining unit configured to obtain supported scheme information relating to a network setup scheme supported by the communication apparatus, and
a transmission control unit configured to control the information processing apparatus to transmit to the communication apparatus a specific signal for enabling network setup using a first scheme for connecting the communication apparatus to an access point other than the communication apparatus,
wherein the transmission control unit controls the information processing apparatus to:
transmit the specific signal to the communication apparatus when the supported scheme information indicates that the communication apparatus supports network setup using the first scheme; and
not transmit the specific signal when the supported scheme information indicates that the communication apparatus does not support network setup using the first scheme, and
the communication apparatus includes:
a receiving unit configured to receive a first signal querying supported scheme information relating to a network setup scheme supported by the communication apparatus from the information processing apparatus;
a transmitting unit configured to transmit a response including the supported scheme information as a response to the first signal received by the receiving unit; and
a standby unit configured to wait for a specific signal for enabling network setup using a first scheme for connecting the communication apparatus to an access point other than the communication apparatus when the response is transmitted by the transmitting unit.
